(19) United States
(12) Patent Application Publication
(10) Pub. No.: US 2013/0273319 A1
(43) Pub. Date: Oct. 17, 2013

(54) METHOD FOR TREATING A CONCRETE SURFACE TO PROVIDE A PHOTOCATALYTIC COATING

(71) Applicants: Jeffrey Chen, Lyon (FR); Matthieu Horgnies, Lyon (FR)

(72) Inventors: Jeffrey Chen, Lyon (FR); Matthieu Horgnies, Lyon (FR)

(73) Assignee: LAFARGE, Paris (FR)

(21) Appl. No.: 13/992,476

(22) PCT Filed: Dec. 6, 2011
(86) PCT No.: PCT/EP2011/071839

§ 371 Date: Jun. 7, 2013

(30) Foreign Application Priority Data
Dec. 8, 2010 (FR) 1060230

(51) Int. Cl. B05D 5/02

(52) U.S. Cl. CPC B05D 5/02
USPC 428/142; 427/261

(57) ABSTRACT

A method for the treatment of a concrete surface includes at least partially covering the surface with a first coating which is substantially transparent and substantially impermeable to water; and at least partially covering said first coating with a second coating which is substantially transparent and photocatalytic; the surface having an average roughness Rₐ less than about 10 μm.

The present invention relates to a method for treating a concrete surface to provide a photocatalytic coating

Coatings comprising certain semiconductor materials based on metal oxides referred to as photocatalytic agents, in particular titanium oxides, are capable, under the effect of radiation of a suitable wavelength, of initiating radical reactions which bring about the oxidation of organic products. For example, irradiation by ultraviolet rays of titanium dioxide in the form of very fine particles, in suspension or fixed in various supports, leads to a redox reaction capable of degrading organic pollutants present in the environment. The reaction of the photocatalytic agents with water in the atmosphere may also lead to the formation of superhydrophilic groups on the surface of the coating, which favour the formation and the flow of a film of water and therefore improve the cleaning of the concrete surface.

By way of example, International Patent Application WO200100541 filed in the name of Italcementi describes a coating comprising titanium dioxide particles which can be used to cover a concrete element.

However, for certain applications, the self-cleaning capacities which the photocatalytic coating gives to the concrete element may not be sufficient.

For certain applications, it may be desirable to preserve the visual appearance of the untreated concrete. It is then necessary for the photocatalytic coating to be transparent. However, the covering of a concrete element by a transparent coating generally leads to a shiny surface being obtained which is characteristic of the presence of the coating. Furthermore, in particular because of the phenomenon of efflorescence of the concrete, unattractive light or dark patches can appear on the surface covered by the coating or at the interface between the concrete and the coating, and cannot be concealed by the transparent coating.

The present invention seeks to provide a concrete element covered by a photocatalytic transparent coating for which the self-cleaning capacity of the surface is improved; for which the visual appearance of the surface of the concrete element remains substantially that of a concrete which is not covered by a coating and is matt not shiny; which reduces or prevents the appearance of light or dark patches on the surface covered by the coating or at the interface between the concrete and the coating, due to efflorescence; which reduces or prevents blistering of the coating in a humid atmosphere; and/or which facilitates the cleaning of stains on the surface.

The invention can be implemented in at least one industry such as the building industry, the chemical (admixtures) industry and the cement industry, or in the construction markets (for example in building, civil engineering, roads or precasting works).

Surprisingly, the inventors have demonstrated that the covering of high-performance concrete, in particular ultra-high-performance concrete, with at least two coatings, the first being a substantially impermeable and substantially transparent coating, the second being a substantially impermeable and substantially transparent coating and comprising a photocatalytic agent, makes it possible to obtain a concrete element treated with a photocatalytic coating which may preserve, or help to preserve, at least partially, the matt visual appearance of the untreated material.

One explanation could be that high-performance concrete, in particular ultra-high-performance concrete, has a low surface roughness. The flow on the surface of the concrete of the film water formed by the action of the photocatalytic coating may then be facilitated. The cleaning action of the photocatalytic coating is then improved. Furthermore, because of the low surface roughness of the concrete the presence of the transparent coating may modify the visual appearance of the concrete element slightly or not at all. Moreover, high-performance concrete, in particular ultra-high-performance concrete, has a low open surface porosity, thus facilitating sealing of the surface.

The fact that the second coating is separate from the first coating makes it possible to optimize the properties of each coating and helps to lead to advantages (improvement in the cleaning of the treated concrete element, preserved visual appearance of the raw concrete and/or absence or reduction of surface patches or stains) which could not be obtained in the case where the concrete element is covered by one single coating.

The present invention accordingly provides a method for the treatment of a concrete surface, which method comprises:
at least partially covering the surface with a first coating which is substantially transparent and substantially impermeable to water; and
at least partially covering said first coating with a second coating which is substantially transparent and photocatalytic;
the concrete surface having an average roughness Rₐ less than about 10 μm.

The present invention also provides an element comprising a high-performance concrete, in particular an ultra-high-performance concrete, covered at least in part by a first coating which is substantially transparent and substantially impermeable to water, the first coating being covered at least in part by a second coating which is substantially transparent and photocatalytic, the concrete surface having an average roughness Rₐ less than about 10 μm.

The expression “roughness” means the irregularities of a surface of the order of a micron, which are defined by comparison with a reference surface and are classified into two categories: bumps or peaks or protrusions, and cavities or depressions. The roughness of a given surface can be determined by measuring a certain number of parameters. In the following description the parameter Rₐ is used, as defined by the standards NF E 05-015 and ISO 4287, corresponding to the arithmetic mean of all the ordinates of the profile within a base length of 12.5 mm.

In this specification, including the accompanying claims, surface roughness is measured using a Mitutoyo SURFTEST SJ-201 apparatus having a sensor. The parameter Rₐ is measured five times over a distance of 12.5 mm and an average value calculated. The surface over which the measurements are made is chosen to be free of visible bubbles, scratches or other defects, which might affect the measured average value.

The roughness of a ultra high performance concrete (UHPC) is generally 2 μm or less, for example about 1 μm. The roughness of other concrete, for example high performance concrete (HPC), when well cast, is generally about 5 μm. When the casting is poor, for example if excessive demoulding oil is used, or if too much water is present in the concrete mix or if ordinary concrete is used, the Rₐ value generally exceeds 10 μm. The number of surface defects such as bubbles may then effectively prevent accurate measurement of the Rₐ value and of water contact angles. The concrete surface treated according to the method of the invention is preferably substantially free from visible defects.

According to an embodiment of the invention, the first coating comprises a waterproofing agent, that is to say an agent adapted to render the coating substantially impermeable to water. The first coating generally comprises from 5 to 50% by weight, preferably from 5 to 40% by weight, most preferably from 5 to 30% by weight, of dry extract of the waterproofing agent. The content of waterproofing agent is preferably more than 10% by weight, preferably more than 20% by weight, even more preferably more than 25% by weight of the waterproofing agent. The waterproofing agent may be diluted in a solvent, for example, a petroleum-based solvent (e.g. white spirit or the product Roticlear available from Roth, Germany), in order to facilitate application of the agent.

The waterproofing agent may be a salt, in particular a metal salt, of a fatty acid, or a fatty acid ester, or a mixture of fatty acid salts and/or esters. Examples of fatty acid salts include stearic acid (octadecanoic acid), palmitic acid (hexadecanoic acid), lauric acid (dodecanoic acid) or oleic or linoleic acid. Waterproofing agents also include waxes (in particular paraffin waxes) or natural or synthetic oils. The waterproofing agent is preferably a compound based on silicon, in particular chosen from silanes (for example organosilanes), siloxanes, siliconates (for example sodium methylsilicate or potassium methylsilicate), or silicones (polysiloxanes) or mixtures thereof. Silanes are preferably monomers of general formula Si(R)₄, wherein the substituents R, which may be identical or different, may represent for example a hydrogen or halogen atom (in particular chlorine), a C₁ to C₈, preferably C₃ to C₈ alkyl group (optionally fluorinated or aminated), or a C₁ to C₈, preferably C₁ to C₄ alkoxy group (in particular ethoxy). Siloxanes are preferably oligomers comprising [Si(R)₂O]ₙ units, wherein n is greater than or equal to 2. The groups R, which may be identical or different, may for example be C₁ to C₈, preferably C₁ to C₄ alkyl groups. When n is large, siloxanes or polysiloxanes or organosiloxanes are commonly referred to as silicones. A mixture of silane and siloxane may be employed. An example of a silicone that may be employed is polydimethylsiloxane (PDMS).

According to one embodiment, the first coating comprises an organosilane or an organosilane derivative. This may be for example an alkoxysilane or an alkoxysilane derivative. By way of example, the organosilane or the organosilane derivative has the formula (1):

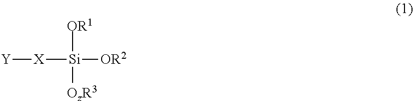

wherein R¹, R², R³ each independently represent hydrogen, a C₁ to C₆ alkyl group, an aryl group, e.g. phenyl, a (C₁ to C₆ alkyl)aryl group, e.g. phenylalkyl, or an aryl (C₁ to C₆ alkyl) group, z is equal to 0 or 1, Y represents a substituted or unsubstituted glycidyl group, or a substituted or unsubstituted amine or halogenated group (in which the halogen is preferably fluorine or chlorine), and X is an unsubstituted or substituted hydrocarbenzyl group, e.g. —(CₙH₂ₙ—), wherein n is 1 to 6, for example 1 to 4, e.g. methylene.

According to an embodiment of the invention, the organosilane comprises dialkoxy and/or trialkoxyorganosilanes defined by the formula (2):

R—Si(R′)ₓ(OR′)₃₋ₓ (2)

wherein R is a C₁ to C₁₀ alkyl group, or an alicyclic (preferably C₃ to C₆), aryl, e.g. phenyl, vinyl, or methacryl group; R′ represents a methyl or ethyl group, and x is equal to 0 or 1. Examples of such organosilanes comprise isobutyltrimethoxysilane, vinyltrimethoxysilane, n-octyltrimethoxysilane, methyltrimethoxysilane, trimethoxy(2,4,4-trimethylpentyl)silane and n-propyltrimethoxysilane.

In this specification, including the accompanying claims, unless otherwise specified alkyl groups and moieties may be straight- or branched-chain.

By way of example, the step of covering the said element with the first coating comprises the step of depositing a first, generally homogeneous, substantially transparent and substantially impermeable layer on at least a part of said element. According to an embodiment, the step of covering said element with the first coating comprises the step of depositing a first substantially transparent layer comprising a waterproofing agent on at least a part of said element.

After the release of the element from the mould and before the step of covering said element with the first coating, a step of storing the element for at least 7 days, preferably at least 10 days, even more preferably at least 12 days, is carried out. The storage is for example carried out at 20° C. and at 50% relative humidity.

The first layer may comprise an emulsion comprising droplets of the waterproofing agent in a solvent, for example water or an organic solvent, for example heptane. Preferably, the first layer comprises an emulsion comprising more than 10% by weight, preferably more than 20% by weight, even more preferably more than 25% by weight of the waterproofing agent.

After preparation and before application, the first layer generally has a liquid consistency. Once applied to the face of the concrete element, part or all of the solvent of the first layer may evaporate. The first coating corresponds to the first layer after any evaporation of the solvent.

The application of the first layer is generally effected by brushing, spraying or by soaking, preferably by spraying (in particular if the concrete structure to be treated has large dimensions).

The quantity of liquid applied is preferably sufficient to completely cover the concrete surface to be treated. The first layer may be applied in several stages. By way of example, the final quantity applied is from 70 to 250 g/m², preferably from 70 to 150 g/m², even more preferably from 75 to 110 g/m².

Preferably, the first layer is left to dry before the deposition of the second coating. By way of example, after the deposition of the first layer it is left for least 4 hours, preferably at least 6 hours at 20° C.

According to an embodiment, the second coating comprises a photocatalytic agent and an organic binder, preferably diluted in a solvent in order to facilitate application of the liquid product.

The second coating generally comprises from 0.1 to 20% by weight, preferably from 0.1 to 10% by weight, even more preferably from 1 to 10% by weight of the photocatalytic agent.

The second coating may also comprise from 0.1 to 30% by weight, preferably from 0.1 to 10% by weight, even more preferably from 1 to 10% by weight of mineral fillers or pigments (for example comprising silica type or TiO₂ in, for example the rutile form).

The second coating generally comprises from 0.1 to 50% by weight, preferably from 1 to 50% by weight, even more preferably from 10 to 30% by weight of the organic binder.

Preferably, the step of covering said first coating with the second coating comprises the following steps:
covering said first coating with a second substantially transparent layer comprising the organic binder; and
covering said second layer with a third substantially transparent layer comprising the photocatalytic agent and/or the mineral fillers.

After preparation and before application, the second layer generally has a liquid consistency. Likewise, after preparation and before application, the third layer generally has a liquid consistency. Once applied to the first coating and after drying, the second and third layers form the second coating covering the first coating. During drying, part or all of the solvents of the second and third layers may evaporate.

Preferably, the organic binder comprises one or more organic polymers. The second coating preferably comprises an acrylic polymer or a derivative of an acrylic polymer. The organic binder may be a sacrificial binder, intended to be degraded by the action of the photocatalytic agent. The organic binder may also comprise a fluorinated polymer which is resistant to photocatalytic attack, for example a fluorinated acrylic polymer, or a polytetrafluoroethylene (PTFE), polyvinylidene fluoride (PVDF) or an ethylene/tetrafluoroethylene (ETFE) copolymer. The organic binder may be a copolymer of a (meth)acrylic monomer and of a monomer according to formula (2) and optionally other monomers. The organic binder may be an acrylic polymer modified by silicones.

The second layer may comprise a dispersion comprising particles of organic binder in a solvent, for example water. The binder may be introduced into the coating composition in the form of a solution.

Preferably, the second layer comprises an emulsion generally comprising from 10 to 40% by weight, preferably 15 to 35%, more preferably 20 to 30%, of the organic binder.

The application of the second layer is generally effected by brushing, by spraying or by soaking, preferably by spraying (in particular if the concrete structure to be treated has large dimensions).

When the second layer is applied one or more times to the first layer by spraying, the quantity of liquid applied is preferably sufficient to completely cover the first layer. By way of example, the final quantity sprayed is from 60 to 160 g/m², preferably from 80 to 120 g/m².

The second layer is preferably left to dry before the deposition of the third layer. By way of example, after the deposition of the second layer, at least 1 hour is left, preferably at least 3 hours at 20° C.

The photocatalytic agent according to the invention may comprise a metal oxide, which is at least partially crystallized, for example zinc oxide, tin oxide or tungsten oxide. The preferred example according to the invention comprises titanium oxide, which is preferably at least partially crystallized in the form of anatase, which is the crystalline phase, which gives the titanium dioxide its photocatalytic properties. The agent may also comprise a sulfide, preferably at least partially crystallized, such as zinc sulfide or boron sulfide. It is possible to employ other photocatalytic agents such as for example alkaline earth oxides, actinide oxides and rare earth oxides. In the following text, for the sake of simplicity, reference will be made to titanium oxide, it being understood that all of the indications given will also apply to the other materials. The second coating preferably comprises particles of titanium dioxide.

When the second coating according to the invention is being produced, at least a part of the photocatalytic agent (in particular all or the majority) may be incorporated in the coating in the form of preformed particles. Particles of nanometre size are preferred. These particles are generally in the form of agglomerates of crystallites, the agglomerates generally having a mean size from several nanometers to several tens of nanometers. They are generally manipulated in the form of a dispersion in a liquid phase, for example in colloidal suspension in an aqueous medium or in dispersion in one or more organic solvents. The mean sizes may correspond to theoretical diameters, approximated in shape to spheres (even if this is not necessarily the case, as the particles may have a lenticular shape or a rod shape). Particle sizes are measured by laser diffraction as described in more detail hereinafter.

Preferably, the third layer is a suspension, for example a colloidal suspension of the photocatalytic agent in an aqueous medium comprising from 0.1 to 8% by weight, even more preferably from 0.2 to 5%, of the photocatalytic agent.

The aqueous medium may also comprise silicon dioxide, generally in a quantity of 0.2 to 15%, preferably 0.5 to 10%.

The aqueous medium may also comprise a silicone modified polyether, generally in a quantity of 0.1 to 0.5%, preferably about 0.3%.

The application of the third layer is generally effected by brushing, by spraying or by soaking, preferably by spraying (in particular if the concrete structure to be treated has large dimensions).

When the third layer is applied on the second layer, for example by spraying, the quantity of liquid applied is preferably sufficient to completely cover the second layer. By way of example, the quantity sprayed is from 5 to 20 g/m², preferably from 10 to 15 g/m².

The first and/or second coating may comprise a coalescent agent, for example a solvent with a high boiling point which, when it is added to the composition of a coating, aids the formation of a film by temporary plastification of the coating. The coalescent agent may be a glycol ether. The first and/or second coating may comprise an anti-foam agent, that is to say a chemical additive which reduces or prevents the formation of foam in a liquid composition. This may be the anti-foam agent marketed by Tego under the name Tego foamex 825. The first and/or second coating may also comprise a biocide, that is to say a chemical agent that is capable of destroying living organisms. This may be the biocide marketed by Thor under the name Acticide MBS.

The present invention also embraces an element comprising a concrete, for example a high-performance treated concrete by the method described above. This is preferably an element for the field of construction.

The concrete constituting the element on which the coating is applied generally has a water/cement ratio (W/C) of up to 50%, preferably at most 0.32, for example 0.10 to 0.32, more preferably from 0.20 to 0.27.

The concrete may be a concrete containing silica fume.

The concrete generally has a porosity to water of less than 14%, preferably less than 12%, for example less than 10% (determined by the method described in the report “Journées Techniques”, AFPC-AFREM, December 1997, pages 121 to 124).

The concrete generally has a roughness Rₐ from 0.5 to 10 μm, preferably from 0.5 to 7 μm, even more preferably from 0.5 to 5 μm, advantageously from 0.5 to 3 μm. Contrary to what might be expected it is generally easier to obtain a matt finish of the coating as the roughness of the concrete surface decreases, i.e. when the surface is smoother.

The concrete generally has a resistance to compression measured at 28 days from 50 to 300 MPa, for example 80 to 250 MPa. The concrete may be a high-performance concrete, which is to say a concrete in which the resistance to compression at 28 days is greater than 50. The concrete is preferably an ultra-high-performance concrete (UHPC), for example containing fibers. An ultra-high-performance concrete is a particular type of high-performance concrete and generally has a resistance to compression at 28 days greater than 100 MPa and generally greater than 120 MPa. The coating according to the invention is preferably applied to elements produced from the ultra-high-performance concretes described in the U.S. Pat. Nos. 6,478,867 and 6,723,162 or European Patent Applications 1958926 and 2072481.

The evaluation of the self-cleaning properties of a concrete surface may be effected by producing stains on the surface, leaving the stains to dry for several hours, wiping the surface with water using a cloth or a sponge, then exposing the concrete surface to sunlight for four weeks. Examples of stains against which the photocatalytic coating according to the invention is effective are given in the following Examples. They comprise one or more stains caused by aqueous liquids, for example tea, coffee, carbonated drinks and wine, vegetable oils such as sunflower oil, paints and inks, acrylic paints, for example, markers and felt pens, methylene blue and methyl violet.

The concrete preferably comprises, in parts by weight:
100 parts of Portland cement;
50 to 200 parts of a sand having a single grading with a D10 to a D90 of 0.063 to 5 mm, or a mixture of sands, the finest sand having a D10 to a D90 of 0.063 to 1 mm and the coarsest sand having a D10 to a D90 of 1 to 5 mm, for example between 1 and 4 mm;
0 to 70 parts of a pozzolanic or non-pozzolanic material of particles or a mixture thereof having a mean particle size less than 15 μm;
0.1 to 10 parts of a water-reducing superplasticizer; and
10 to 32 parts of water.

D90, also denoted D_{V}90, corresponds to the 90^{th} percentile of the particle size distribution by volume, that is to say that 90% of the particles have a size less than D90 and 10% have a size greater than D90. Likewise, D10, also denoted D_{V}10, corresponds to the 10^{th} percentile of the particle size distribution by volume, that is to say that 10% of the particles have a size less than D10 and 90% have a size greater than D10.

The sand is generally a silica or limestone sand, a calcined bauxite or particles of metallurgical residues, and may also comprises a ground dense mineral material, for example a ground vitrified slag. A preferred mixture of sands comprises a mixture (preferably of two sands), the finest sand having a D10 to a D90 from 0.063 to 1 mm and the coarsest sand having a D10 to a D90 from 1 to 5 mm.

The concrete according to the invention is preferably a self-placing concrete. It preferably has a Vicat setting time of 2 to 18 hours, for example 4 to 14 hours.

The ultra-high-performance concretes generally exhibit a greater shrinkage on setting because of their higher cement content. The total shrinkage may be reduced by the inclusion of, in general from 2 to 8 parts, preferably from 3 to 5 parts, for example approximately 4 parts, of quicklime, overburnt lime or calcium oxide per 100 parts of the mixture before the addition of water.

Suitable pozzolanic materials comprise silica fume, also known under the name of microsilica, which is a by-product of the production of silicon or ferrosilicon alloys. It is known as a reactive pozzolanic material.

Its principal constituent is amorphous silicon dioxide. The individual particles generally have a size of approximately 5 to 10 nm. The individual particles agglomerate to former agglomerates of 0.1 to 1 μm, and then can aggregate together in aggregates of 20 to 30 μm. The silica fume generally has a specific surface area BET of 10 to 30 m²/g.

Other pozzolanic materials comprise materials rich in aluminosilicate such as metakaolin and natural pozzolans having volcanic, sedimentary or diagenic origins.

Suitable non-pozzolanic materials also comprise materials containing calcium carbonate (for example ground or precipitated), preferably a ground calcium carbonate. The ground calcium carbonate may for example be Durcal® 1 (OMYA, France).

The non-pozzolanic materials preferably have a mean particle size less than about 10 μm, preferably less than about 5 μm, for example 1 to 4 μm. The non-pozzolanic material may be a ground quartz, for example C800 which is a substantially non-pozzolanic silica filler material supplied by Sifraco, France.

The preferred specific surface area BET (determined by known methods) of the calcium carbonate or of the ground quartz is generally from 2 to 10 m²/g, generally less than 8 m²/g, for example 4 to 7 m²/g, preferably less than 6 m²/g.

Precipitated calcium carbonate is also suitable as non-pozzolanic material. The individual particles generally have a (primary) size of the order of 20 nm. The individual particles agglomerate in aggregates having a (secondary) size of approximately 0.1 to 1 μm. The aggregates themselves form clusters having a (ternary) size greater than 1 μm.

A single non-pozzolanic material or a mixture of non-pozzolanic materials may be used, for example ground calcium carbonate, ground quartz or precipitated calcium carbonate or a mixture thereof. A mixture of pozzolanic materials or a mixture of pozzolanic and non-pozzolanic materials may also be used.

The concrete treated according to the invention may be reinforced by reinforcing elements, for example metal and/or organic fibers and/or glass fibers and/or other reinforcing elements for example as described below.

The compositions according to the invention may comprise metal fibers and/or organic fibers and/or glass fibers. The quantity by volume of fibers is generally from 0.5 to 8% relative to the volume of the hardened concrete. The quantity of metal fibers, expressed in terms of volume of the final hardened concrete is generally less than 4%, for example from 0.5 to 3.5%, preferably approximately 2%. The quantity of organic fibers, expressed on the same basis, is generally from 1 to 8%, preferably from 2 to 5%. The metal fibers are generally chosen from the group including steel fibers, such as high strength steel fibers, amorphous steel fibers or stainless steel fibers. The steel fibers may optionally be coated with a non-ferrous metal such as copper, zinc, nickel (or alloys thereof).

The individual length (l) of the metal fibers is generally at least 2 mm and is preferably 10 to 30 mm. The ratio l/d (d being the diameter of the fibers) is generally from 10 to 300, preferably from 30 to 300, preferably from 30 to 100.

Fibers having a variable geometry may be used: they may be crimped, wavy or hooked at the ends. The roughness of the fibers may also be modified and/or fibers of variable section may be used. The fibers may be obtained by any appropriate technique, including by braiding or cabling several metal wires in order to form a twisted assembly.

The adhesion of the metal fibers in the cement matrix may be favored by the treatment of the surface of the fibers. This treatment of the fibers may be effected by one or more of the following processes: etching of the fibers or deposition of a mineral compound on the fibers, in particular by the deposition of silica or of a metal phosphate.

The etching may be effected for example by contacting the fibers with an acid, then carrying out neutralization.

Silica may be deposited by contacting the fibers with a silicon compound, such as a silane, a siliconate or a colloidal silica solution. It will be understood that the silica or the phosphate is substantially limited to the surface of the metal fibers in the concrete matrix and is not uniformly dispersed in the matrix.

Phosphatizing treatments are known and are described for example in the article by G. LORIN entitled “The Phosphatizing of Metals” (1973), Pub. Eyrolles.

In general, a metal phosphate is deposited by implementing a phosphatizing process, which comprises the introduction of metal fibers etched in an aqueous solution comprising a metal phosphate, preferably manganese phosphate or zinc phosphate, then filtering the solution in order to recover the fibers: the fibers are then rinsed, neutralized and rinsed again. Contrary to the usual phosphatizing process, the fibers obtained do not have to undergo a finishing step of the lubrication type. However, they may optionally be impregnated with an additive for the purpose of ensuring protection against corrosion or making it easier to use them in a cement environment. The phosphatizing treatment may also be effected by coating or spraying the fibers with a metal phosphate solution.

The organic fibers comprise polyvinyl alcohol (PVA) fibers, polyacrylonitrile (PAN) fibers, fibers of polyethylene (PE), high-density polyethylene (HDPE) fibers, polypropylene (PP) fibers, homo- or copolymers, polyamide or polyimide fibers. Mixtures of these fibers may be used. The organic reinforcing fibers used in the invention may be classified as follows: high modulus reactive fibers, low modulus non-reactive fibers and low modulus reactive fibers. The presence of organic fibers makes it possible to modify the behavior of the concrete in relation to heat or fire.

The fusion of the organic fibers makes it possible to develop routes by which vapor or water under pressure can escape when the concrete is exposé to high temperatures.

The organic fibers may be present in the form of individual filaments or bundles of several filaments. The diameter of the single filament or of the bundle of multiple filaments is preferably from 10 to 800 μm. The organic fibers may also be used in the form of woven structures or non-woven structures or a hybrid bundle comprising different filaments.

The individual length of the organic fibers is preferably from 5 to 40 mm, preferably from 6 to 12 mm. The organic fibers are preferably PVA fibers.

The optimal quantity of organic fibers used depends in general on the geometry of the fibers, the chemical nature thereof and the intrinsic mechanical properties thereof (for example the modulus of elasticity, the flow threshold, the mechanical resistance).

The ratio l/d, d being the diameter of the fiber and l the length, is generally from 10 to 300, preferably from 30 to 90.

The glass fibers may have a single filament (monofilament fiber) or multiple filaments (multifilament fiber), each individual fiber then comprising a plurality of filaments.

The glass fibers may be formed by the flow of molten glass through a die. A conventional aqueous sizing composition may then be applied to the glass fibers. Aqueous sizing compositions may include a lubricant, a coupling agent and a film forming agent and optionally other additives. The treated fibers are generally heated to eliminate water and to effect a heat treatment of the sizing composition on the surface of the fibers.

By way of example, the sizing may be effected by means of a composition which comprises a silane coupling agent.

The silane coupling agents comprise aminosilanes, silane esters, vinylsilanes, methacryloxysilane, epoxysilanes, sulfur silanes, ureidosilanes, isocyanatosilanes and mixtures thereof.

The film forming agents comprise blocked polyurethane film forming materials, thermoplastic polyurethane film forming materials, epoxy resin film forming materials, polyolefins, modified polyolefins, functionalized polyolefins, polyvinyl acetate, polyacrylates, saturated polyester resin film forming materials, unsaturated polyester resin film forming materials, polyether film forming materials and mixtures thereof. The glass in the fibers is generally alkali resistant. The fibers may be sized to promote the resistance to abrasion and/or the integrity of the filaments during mixing of the concrete. Furthermore, for the multifilament fibers the sizing may be provided in order to avoid or to reduce the separation of the filaments during mixing.

A treatment for coating the glass fibers is performed in such a way as to avoid or to reduce the presence of porosity around the glass fibers in the cement matrix. This treatment for coating the glass fibers may be effected by deposition of a mineral compound comprising silica on the glass fibers. This is preferably reactive silica having a pozzolanic action.

The percentage by volume of glass fibers in the concrete is preferably greater than 1% by volume, for example from 2 to 5%, preferably approximately 2 to 3%, a preferred value being approximately 2%.

The diameter of the individual filaments in the multifilament fibers is generally less than approximately 30 μm. The number of individual filaments in each individual fiber is generally from 50 to 200, preferably approximately 100 or approximately 200. The composite diameter of the multifilament fibers is generally from 0.1 to 0.5 mm, preferably approximately 0.3 mm. They generally have an approximately circular or oval shape in cross-section.

The glass generally has a Young's modulus greater than or equal to 60 GPa, preferably from 70 to 80 GPa, for example from 72 to 75 GPa, and is preferably approximately 72 GPa.

The length of the glass fibers is generally greater than the size of the granulate (or sand) particles. The length of the fibers is preferably at least three times greater than the size of the particles. A mixture of lengths may be used. The length of the glass fibers is generally from 3 to 20 mm, for example from 4 to 20 mm, preferably from 4 to 12 mm, for example approximately 6 mm or approximately 12 mm.

The tensile strength of the glass multifilament fibers is approximately 1700 MPa or more.

The rate of saturation of the glass fibers (S_{f}) in the composition is expressed by the formula:

S_{f}=V_{f}×L/D

where V_{f} is the real volume of the fibers, L is the fibre length and D is the fibre diameter. In the cement treated according to the invention S_{f} is generally from 0.5 to 5, preferably from 0.5 to 3. In order to obtain a good fluidity of the mixture of fresh concrete S_{f} may generally be up to approximately 2. The real volume may be calculated on the basis of the weight and the density of the glass fibers.

Binary hybrid fibers comprising glass fibers and (a) metal fibers or (b) organic fibers and hybrid ternary fibers comprising glass fibers, metal fibers and organic fibers may also be used. A mixture of glass fibers, organic fibers and/or of metal fibers may also be used: thus a “hybrid” composite is obtained, the mechanical behavior of which may be adapted as a function of the desired performance. The compositions preferably comprise polyvinyl alcohol (PVA) fibers. The PVA fibers generally have a length of 6 to 12 mm. They generally have a diameter of 0.1 to 0.3 mm.

The use of mixtures of fibers having different properties and lengths makes it possible to modify the properties of the concrete that contains them.

Suitable cements are the Portland cements without silica fume described in “Lea's Chemistry of Cement and Concrete”. Portland cements include slag cements, pozzolanic, fly ash, burnt shale, limestone and composite cements. A preferred cement for the invention is CEM I (generally PM ES). The cement in the concrete according to the invention is for example a white cement.

The water/cement weight ratio of the composition according to the invention may vary if cement substitutes, more particularly pozzolanic materials, are used. The water/binder ratio is defined as the weight ratio between the quantity of water E and the sum of the quantities of cement and of all pozzolanic materials: it is generally from 13 to 35%, preferably 15 to 32%, for example 15 to 30%, most preferably from 20 to 25%. The water/binder ratio may be adjusted by using for example water reducing agents and/or superplasticizers.

In the work “Concrete Admixtures Handbook, Properties Science and Technology”, V. S. Ramachandran, Noyes Publications, 1984:

A water reducer is defined as an additive that reduces the quantity of water of the mixture for a concrete for a given workability of typically from 10 to 15%. Water reducers comprise for example lignosulfonates, hydroxycarboxylic acids, carbohydrates, and other specialized organic compounds, for example glycerol, polyvinyl alcohol, sodium aluminomethylsiliconate, sulfanilic acid and casein.

Superplasticizers belong to a new class of water reducers which are chemically different from the normal water reducers and capable of reducing the quantity of water of the mixture by approximately 30%. Superplasticizers have been classified generally into four groups: sulfonated naphthalene formaldehyde (SNF) condensate (generally a sodium salt); sulfonated melamine formaldehyde condensate (SMF); modified lignosulfonates (MLS) and others. New generation superplasticizers comprise polycarboxylic compounds such as polyacrylates. The superplasticizer is preferably a new generation of superplasticizer, for example a copolymer containing polyethylene glycol as graft and carboxylic functions in the main chain such as a polycarboxylic ether. Sodium polycarboxylate-polysulfonate and sodium polyacrylates may also be used. The quantity of superplasticizers generally required depends on the reactivity of the cement. The lower the reactivity of the cement, the lower the required quantity of superplasticizer. In order to reduce the total quantity of alkalis, the superplasticizer may be used as a calcium salt rather than a sodium salt.

Other additives may be added to the concrete mix, for example an anti-foam agent (for example a polydimethylsiloxane). Silicones may also be used in the form of a solution, a solid or preferably in the form of a resin, an oil or an emulsion, preferably in water. Preferred silicones comprise the characteristic groups (R⁴SiO0.5) and (R⁴₂SiO).

In these formulae the radicals R⁴, which may be identical or different, are preferably hydrogen or an alkyl group having 1 to 8 carbon atoms, the methyl group being preferred. The number of characteristic groups is preferably from 30 to 120.

The quantity of such an agent in the composition is generally at most 5 parts per 100 parts by weight relative to the weight of the cement.

The concretes treated according to the invention may also comprise hydrophobic agents to increase the repulsion of water and to reduce the absorption of water and the penetration into the solid structures treated. Such agents comprise silanes, siloxanes, silicones and siliconates; commercially available products comprise liquid products and solid products (for example as granules) which can be diluted in a solvent.

The concrete may be prepared by known methods, in particular by mixing the solid components and water, shaping (for example by moulding, casting, injection, pumping, extrusion or calendering) then setting and hardening.

It may also have a compressive strength R_{c} of at least 100 MPa.

In order to prepare the concrete according to the invention, the constituents and the reinforcing fibers are mixed with water. The following order of mixing may for example be adopted: mixing the powdered constituents of the matrix; introduction of water and a fraction, for example half, of the additives; mixing; introduction of the remaining fraction of the additives; mixing; introduction of the reinforcing fibers and of the other constituents; mixing.

The method of fabricating a concrete element as defined above comprises the steps of providing a mould, pouring the concrete in the fresh state into the mould and removing the element from the mould after the concrete has set. The filling of the mould is advantageously carried out with the mould flat.

According to an embodiment of the invention, the mould comprises a material such as silicone, polyurethane, steel, stainless steel, polypropylene, bakelized wood, polyoxymethylene or polyvinyl chloride. The mould preferably comprises polypropylene, polyoxymethylene or polyvinyl chloride.

According to an embodiment of the invention, the mould comprises silicone. Advantageously, when the mould comprises silicone it may not be necessary to use a mould release composition or a composition for release from formwork in order to facilitate the removal of the concrete element from the mould or formwork.

Preferably, the mould has a roughness Rₐ from 0.1 to 10 μm.

According to an embodiment of the invention, the method further comprises the step of disposing a mould release composition in the mould before the mould is filled with the fresh concrete.

More precisely, according to an embodiment, the method comprises the following steps:
coating the walls of the mould with the mould release composition;
introducing the freshly prepared concrete into the mould; and
removing the concrete part from the mould after hardening and optionally curing of the concrete.

The mould release composition may comprise one or more compounds chosen from the group including a stabilizer, a dispersant, a surfactant, a preservative, a solvent, a thickener and a thixotropic agent, in particular one or more compounds chosen from a waterproofing agent and a pigment.

The concrete may be subjected to a heat treatment or heat curing in order to improve the mechanical properties thereof. The heat treatment is generally carried out at a temperature greater than the ambient temperature, for example from 20 to 90° C., preferably from 60 to 90° C. The temperature of the heat treatment is preferably less than the boiling point of water at ambient pressure, generally at less than 100° C. The use of autoclaving in which the heat treatment is carried out at high pressure allows the use of higher heat treatment temperatures.

The heat treatment may last for example from 6 hours to 4 days, preferably approximately 2 days. The heat treatment starts after setting, generally at least one day after setting has begun, and preferably on concrete which has aged from 1 day to approximately 7 days at 20° C.

Reinforcing means used in association with the concrete treated according to the invention also comprise means for reinforcement by prestressing, for example by adherent wires or by adherent strands, or by post-tension, by non-adherent strands or by cables or by sleeves or bars, the cable comprising an assembly of wires or comprising strands.

The concrete according to the invention will generally be in the form of “thin elements”, for example those having a ratio between the length and the thickness greater than approximately 8, for example greater than about 10, generally having a thickness of 10 to 30 mm. In the mixing of the components of the concrete the materials in the form of particles other than the cement may be introduced as premixtures or dry premix of powders or dilute or concentrated aqueous suspensions.

The expression “hydraulic binder” refers to a material that, mixed with water, forms a paste which sets and hardens as a consequence of hydration reactions and processes and which, after hardening, preserves its resistance and its stability even under water.

The term “concrete” refers to a mixture of hydraulic binder (for example cement), aggregates, water, optionally additives, and optionally mineral additions, such as for example high-performance concrete, ultra-high-performance concrete, self-placing concrete, self-leveling concrete, self-compacting concrete, fiber-reinforced concrete, ready-mixed concrete or colored concrete and includes prestressed concrete. The term “concrete” includes mortars. In this case, the concrete comprises a mixture of hydraulic binder, sand, water and optionally additives and optionally mineral additions. The term “concrete” according to the invention includes fresh concrete or hardened concrete.

The expression “contact angle” or “wetting angle” means the angle formed between the liquid/vapor interface and a solid surface.

The term “emulsion” refers to a homogeneous mixture of two immiscible liquid substances, one substance being dispersed in the second substance in the form of small droplets, the size of which is generally smaller than or of the order of a micron.

The term “suspension” refers to a suspension, for example a colloidal dispersion, in which a finely divided solid product is dispersed in a liquid, the first product being in the form of particles, the size of which is sufficiently small that the first product is not re-deposited quickly.

The expression “element for the construction sector” means any element of a construction such as for example a floor, a screed, a foundation, a basement, a wall, a partition, a lining, a ceiling, a beam, a work surface, a pillar, a bridge pier, a building block, a building block made of aerated concrete, a tube, a pipeline, a post, a staircase, a panel, a cornice, a mould, a highway element (for example a curb), a tile, a covering (for example a road covering), a coating (for example for a wall), a plasterboard, an insulating element (e.g. sound and/or heat insulation).

In this specification including the accompanying claims unless otherwise indicated:

Percentages are by mass:

Specific surface areas of materials are measured by the BET method using a Beckman Coulter SA 3100 apparatus with nitrogen as adsorbed gas.

Particle size distributions and particle sizes less than 0.063 mm are as measured using a Malvern MS2000 laser granulometer. Measurement is effected in ethanol. The light source consists of a red He—Ne laser (632 nm) and a blue diode (466 nm). The optical model is that of Mie and the calculation matrix is of the polydisperse type.

The apparatus is checked before each working session by means of a standard sample (Sifraco C10 silica) for which the particle size distribution is known.

Measurements are performed with the following parameters: pump speed 2300 rpm and stirrer speed 800 rpm. The sample is introduced in order to establish an obscuration between 10 and 20%. Measurement is effected after stabilisation of the obscuration. Ultrasound at 80% is first applied for 1 minute to ensure the de-agglomeration of the sample. After about 30 s (for possible air bubbles to clear), a measurement is carried out for 15 s (15000 analysed images). Without emptying the cell, measurement is repeated at least twice to verify the stability of the result and elimination of possible bubbles.

All values given in the description and the specified ranges correspond to average values obtained with ultrasound.

Particle size distributions and particle sizes greater than 0.063 mm are measured by sieving.

The invention will be described in greater detail by means of the following examples, given without limitation, with reference to the following figures in which:

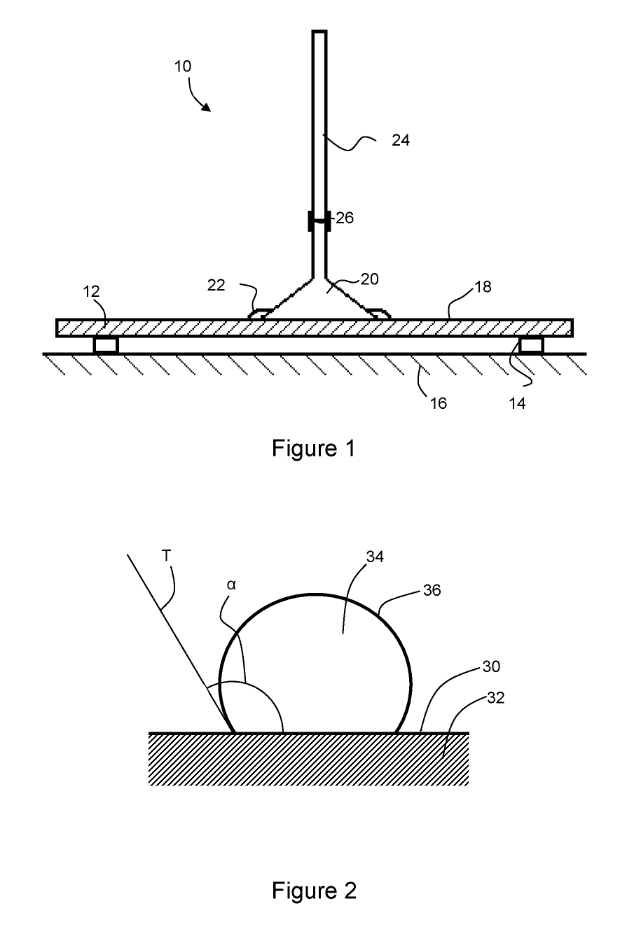

FIG. 1 shows the device for measuring the permeability of a concrete element provided with a coating; and

FIG. 2 shows the principle of measuring a contact angle between a drop of water and a surface.

### EXAMPLES

The present invention is illustrated by the following non-limiting examples. In the examples the products and materials used are available from the following suppliers:

| Product or material | | Supplier |
|---|---|---|
| (1) | Grey Portland cement | Lafarge-France Val |
| | | d'Azergues |
| (2) | White Portland cement | Lafarge-France Le Teil |
| | CEM I 52.5 N CE CP2 NF “blanc” | |
| (3) | Grey Portland cement | Lafarge-France Le Teil |
| | CEM I 52.5 N CE PM-ES-CP2 NF | |
| (4) | Sand 0/4 mm | Lafarge France |
| | | (St Bonnet La Petite Craz) |
| (5) | Sand BE01 (D50 at 307 μm) | Sibelco France |
| | | (SIFRACO BEDOIN quarry) |
| (6) | Gravel 5/10 mm | Lafarge France |
| | | (St Bonnet La Petite Craz) |
| (7) | Limestone filler BETOCARB | OMYA |
| | HP Orgon | |
| (8) | Limestone filler DURCAL 1 | OMYA |
| (9) | Filler SEPR 980 NS | SEPR (Société Européenne |
| | | des Produits Réfractaires) |
| (10) | Silica fume MST | SEPR (Société Européenne |
| | | des Produits Réfractaires) |
| (11) | Additive Ductal F2 | Chryso |
| (12) | Additive CHRYSOFluid Optima | Chryso |
| | 203 | |

The grey Portland cement and the white Portland cement are of the type CEM I 52.5 according to the standard EN 197-1. The additive Ductal F2 is a superplasticizer comprising a polyoxyalkylene polycarboxylate in aqueous phase. The additive CHRYSOFluid Optima 203 is a superplasticizer based on modified polycarboxylate. BETOCARB HP Orgon has a median size of about 8 μm. DURCAL 1 has a D50 of 2 μm. SEPR 980 NS is a silica fume with a median size of about 1 μm.

### Formulation of Ultra-High-Performance Concrete

The formulation (1) of ultra-high-performance concrete used to carry out the tests is described in the following Table 1:

TABLE 1
Formulation 1 of Ultra-High-Performance
Concrete with White Cement

| | Proportion (% by weight |
|---|---|
| | relative to the weight |
| Component | of the composition) |
| White Portland Cement Lafarge Le Teil | 31.0 |
| Limestone filler DURCAL 1 | 9.3 |
| Silica Fume MST | 6.8 |
| Sand BE01 | 44.4 |
| Mixing Water | 7.1 |
| Additive Ductal F2 | 1.4 |

The water/cement ratio is 0.26. This is a concrete having a compressive strength at 28 days greater than 100 M Pa.

The formulation (2) of ultra-high-performance concrete used to carry out the tests is described in the following Table 2:

TABLE 2
Formulation 2 of Ultra-High-Performance
Concrete with Grey Cement

| | Proportion (% by weight |
|---|---|
| | relative to the weight |
| Component | of the composition) |
| Grey Portland Cement Lafarge Le Teil | 31.8 |
| Limestone Filler DURCAL 1 | 7.0 |
| Filler SEPR 980 NS | 9.6 |
| Sand BE01 | 43.6 |
| Mixing Water | 6.9 |
| Additive Ductal F2 | 1.1 |

The water/cement ratio is 0.24. This is a non-fibred ultra-high-performance concrete. It is a concrete having a compressive strength at 28 days greater than 100 MPa.

The formulation (3) of concrete used to carry out the tests is described in the following Table 3:

TABLE 3
Formulation (3) of Concrete with Grey Cement

| | Proportion (% by weight |
|---|---|
| | relative to the weight |
| Component | of the composition) |
| Grey Portland Cement Gris Lafarge Val | 16.5 |
| d'Azergues | |
| Limestone Filler BETOCARB HP Orgon | 9.3 |
| Sand 0/4 (Humidity 2.19%) | 35.8 |
| Gravel 5/10 (Humidity 0.26%) | 29.2 |
| Mixing Water | 8.1 |
| Additive Chrysofluid Optima 203 | 1.1 |

The water/cement ratio is 0.49. This is a concrete having a compressive strength a 28 days less than 100 MPa.

For the concretes the compressive strength at 28 days is for example measured in a manner analogous to that which is described in the standard NF EN 196-1 “Methods Of Testing Cement—Part 1: Determination Of Strength”.

### Method for Preparing the Ultra-High-Performance Concrete According to the Formulation (1) or (2)

The ultra-high-performance concrete according to the formulation (1) or (2) is produced by means of a RAYNERI type mixer. All of the operation is carried out at 20° C. The method for preparation comprises the following steps:
At T=0 seconds: put the cement, the limestone fillers, the silica fume and the sand into the mixer bowl and mix for 7 minutes (15 r.p.m.);
At T=7 minutes: add water and half of the weight of additive and mix for 1 minute (15 r.p.m.);
At T=8 minutes: add the rest of the additive and mix for 1 minute (15 r.p.m.);
At T=9 minutes: mix for 8 minutes (50 r.p.m.); and
At T=17 minutes: mix for 1 minute (15 r.p.m.).
From T=18 minutes: pour the concrete on the level into a PVC mould.
The set concrete is demoulded at about 20 hrs.

In the following Examples, for Formulations (1) and (2), each moulded slab (dimensions 150×100×10 mm) was released from the mould 18 hours after the contact between the cement and the water. Each slab released from the mould was stored at 20° C. and at ambient atmosphere for 14 days.

### Method for Preparing the Concrete According to the Formulation (3)

The concrete is produced by means of a Sipe-type mixer. All of the operation is carried out at 20° C. The method for preparation comprises the following steps:
At T=0 seconds: put the gravel and sand into the mixer bowl and mix for 20 seconds;
At T=20 seconds: add the cement and the filler and mix for 15 (140 r.p.m.); and
At T=35 seconds: add water and the additive and mix for 180 seconds (140 r.p.m.)

At T=4 minutes: pour the concrete vertically into a steel mould covered with demoulding oil. In the following Examples, for Formulation (3) each slab (dimensions 180×120×30 mm) was released from the mould 18 hours after the contact between the cement and the water. Each slab released from the mould was stored at 20° C. and at ambient atmosphere for 14 days.

### Method for Deposition of a Coating (1) According to the Invention

The method is carried out at 20° C. and comprises the following steps:
waiting 14 days after the release from the mould of the concrete slab to be treated;
the deposition on the face of the concrete slab to be treated of a first layer of an emulsion comprising from 5 to 15% by weight of polyalkylalkoxysilane diluted in an organic solvent. The emulsion is applied with a roller to the face of the concrete slab to be treated in two applications, with an interval of 6 hours between the two applications and with a quantity of 50 g/m² at each application;
waiting for 6 hours from the drying of the first layer; and
the deposition on the first layer of a photocatalytic coating corresponding to the product HYDROTECT™ CLEAR COAT marketed by Toto.

More precisely, the deposition of the photocatalytic coating comprises the following steps:
the deposition on the first layer of a second layer (HYDROTECT™ CLEAR COAT: MIDDLE COAT) of an emulsion comprising from 20 to 30% by weight of an acrylic resin modified by silicones, 0.1% by weight of N,N-dimethylformamide, 0.2% by weight of ethylene glycol monobutyl ether, 4% by weight of silicone and the rest water. The emulsion is sprayed on the face of the concrete slab to be treated in two applications, with an interval of one hour between the two applications and with a quantity of 50 g/m² sprayed at each application;
waiting for 4 hours from the drying of the second layer; and
the deposition on the second layer of a third layer (HYDROTECT™ CLEAR COAT WATER) of an emulsion comprising from 0.2 to 5% by weight of titanium dioxide, from 0.5 to 10% by weight of silicon dioxide, 0.3% by weight of silicone modified by polyether and the rest water. The emulsion is applied with a short haired roller in one application of a quantity of 12.5 g/m² on the face of the concrete slab to be treated.

### Method for Deposition of a Coating (2) for Comparison

The method is carried out at 20° C. and comprises, after waiting 14 days after the release from the mould of the concrete slab to be treated, the deposition on the face of the concrete slab to be treated of a photocatalytic coating corresponding to the product HYDROTECT™ CLEAR COAT marketed by Toto as was described for the method for deposition of the coating (1).

### Method for Measuring a Wetting Angle or a Contact Angle

FIG. 2 illustrates the principle of measuring a wetting angle between a solid surface 30 of a concrete sample 32 and a drop 34 of a liquid deposited on the surface 30. The reference 36 designates the liquid/gas interface between the drop 34 and the ambient air. FIG. 2 is a section according to a plane perpendicular to the surface 30. In the section plane the wetting angle α corresponds to the angle measured from the interior of the drop 34 of liquid, between the surface 30 and the tangent T to the interface 36 at the point of intersection between the solid 30 and the interface 36.

For measuring the wetting angle, the sample 32 is placed in a room at a temperature of 20° C. and a relative humidity of 50%. A drop of water 34 having a volume of 2.5 μL is disposed on the surface 30 of the sample 32. The angle is measured by an optical method, for example using a device for drop shape analysis, for example the device DSA 100 marketed by Krüss. The measurements are repeated five times and the value of the contact angle measured between the drop of water and the support is equal to the mean of these five measurements.

### Example 1

A concrete according to the formulation (1) was produced. Three slabs were produced by moulding of the concrete according to the formulation (1) in a mould. After storage for 14 days, a surface treatment of the slabs was carried out. The coating (1) according to the invention was disposed on a face of the first slab. The coating (2) for comparison was disposed on a face of the second slab. No coating was disposed on the third slab.

Seven days after the surface treatment the slabs were subjected to a stain formation test consisting of using different products to produce the stains on the concrete slabs. For each product used a stain was produced on each slab.

The products used for producing the stains are as follows:

espresso coffee;

red wine;

lemon juice;

methylene blue;

sunflower oil; and

permanent marker.

After the production of the stains, the slabs were left in ambient air for four hours at ambient temperature. After 4 hours each slab was cleaned with a cloth wetted with water. A photograph of the marked surface of each slab was then taken. Each slab was then disposed outside, in sunlight, for 10 days. Then a photograph of the surface of the slab was again taken. The results of a visual comparison of the two photographs are presented in the following Table 4:

TABLE 4

| | | Development of the | Development of the |
|---|---|---|---|
| | Development of the | stain after 10 days for | stain after 10 days |
| | stain after 10 days | the first slab comprising | for the second slab |
| | for the third slab | the coating (1) according | comprising the coating |
| Product | without coating | to the invention | (2) for comparison |
| espresso coffee | slightly reduced | completely | completely |
| | | disappeared | disappeared |
| red wine | slightly reduced | completely | completely |
| | | disappeared | disappeared |
| lemon juice | completely | completely | completely |
| | disappeared | disappeared | disappeared |
| methylene blue | very slightly | completely | completely |
| | reduced | disappeared | disappeared |
| sunflower oil | very slightly | completely | completely |
| | reduced | disappeared | disappeared |
| permanent | very slightly | slightly reduced | slightly reduced |
| marker | reduced | | |

The concrete element covered by the coating (1) and the concrete element covered by the coating (2) exhibit surface properties which make it possible to degrade the stains produced during the exposure to sunlight.

### Example 2

A concrete according to the formulation (2) was produced. Two slabs were produced by moulding of the concrete according to the formulation (2). After the storage for 14 days, a surface treatment of the slabs was carried out. A coating (1) was disposed on a face of the first slab. A coating (2) was disposed on a face of the second slab.

FIG. 1 shows the device 10 used for carrying out a measurement of the permeability of a slab 12. The slab 12 is disposed on spacers 14 at approximately 5 mm from a horizontal support 16. The treated face of the slab 12 is the upper face 18. A funnel in the shape of a truncated cone 20 with a vertical axis is placed on the upper face 18, the end of the funnel 20 of large diameter being in contact with the upper face 18. The largest diameter of the funnel is 75 mm. A sealing gasket 22 covers the contact zone between the funnel 20 and the face 18. Moreover the end of the funnel 20 small diameter is extended by a graduated pipette 24. A sealing gasket 26 covers the contact zone between the funnel 20 and the pipette 24.

After the surface treatment, the test was carried out for each slab using the testing device of FIG. 1 at a temperature of 20° C. and a relative humidity of 65%. Water was poured into the pipette 24 in such a way as to fill the funnel 20 and the pipette 24 to a height of 250 mm relative to the face 18. The development of the quantity of water penetrating into the slab was measured on the pipette 24. The results are presented in the following Table 5:

TABLE 5

| | | Quantity of water |
|---|---|---|
| | Quantity of water | penetrating the first |
| Time of | penetrating the second | slab comprising the coating |
| measurement | slab comprising the coating | (1) according to the |
| (day) | (2) for comparison (mg) | invention (mg) |
| 0 | 0 | 0 |
| 1 | 0.9 | 0 |
| 2 | 1.8 | 0.25 |
| 3 | 2.7 | 0.5 |
| 4 | 3.5 | 0.75 |

The concrete element covered by the coating (1) according to the invention is therefore more impermeable than the concrete element covered by the coating (2) for comparison.

### Example 3

A concrete according to the formulation (2) was produced. Three slabs were produced by moulding of the concrete according to the formulation (2) in a mould. After storage for 14 days a surface treatment of the slabs was carried out. The coating (1) according to the invention was disposed on a face of the first slab. The coating (2) was disposed on a face of the second slab. No coating was disposed on the third slab.

After the surface treatment, the slabs were stored at 35° C. for 7 days in an atmosphere at 100% humidity. A visual inspection of the treated face of the slabs was carried out with regard to the formation of bubbles in the coating for the first and second slabs and the formation of light and dark patches on the surface of the three slabs and/or at the concrete/coating interface (efflorescences). The results of the visual inspections are presented in the following Table 6:

TABLE 6

| | | | First slab |
|---|---|---|---|
| | | Second slab | comprising the |
| | Third slab | comprising the | coating (1) |
| | without | coating (2) | according to the |
| Visual inspection | coating | for comparison | invention |
| Formation of | — | Formation of | No formation of |
| bubbles | | bubbles in the | bubbles in the |
| | | coating | coating |
| Formation of light | Yes | Yes | No |
| and dark patches | | | |

The concrete element covered by the coating (1) according to the invention does not exhibit patches or bubbles whilst the concrete element covered by the coating (2) for comparison does.

### Example 4

A concrete according to the formulation (2) was produced. A first slab was carried out by moulding of the concrete according to the formulation (2). A concrete according to the formulation (3) was carried out. A second slab (dimensions 180×120×30 mm) was carried out by moulding of the concrete according to the formulation (3). After the storage for 14 days, a surface treatment of the slabs was carried out. The photocatalytic coating (1) according to the invention was disposed on a face of the first and second slabs.

Seven days after the surface treatment, a visual examination of the faces covered by the photocatalytic coating (1) was carried out. The results of the visual inspection of the two photographs are presented in the following Table 7:

TABLE 7

| Visual inspection of the first | Visual inspection of the second |
|---|---|
| slab coveredby the coating (1) | slab covered by the coating (1) |
| according to the invention | according to the invention |
| Visual appearance identical to that | Shiny visual appearance |
| of a concrete without treatment, | |
| that is to say substantially matt | |

For the concrete according to the formulation (3), the substantially shiny visual appearance of the concrete covered by the coating (1) is different from the substantially matt visual appearance of the concrete not covered by the coating (1) whilst for the concrete according to the formulation (1) the substantially matt visual appearance of the concrete covered by the coating (1) is substantially identical to the substantially matt visual appearance of the concrete not covered by the coating (1).

### Example 5

A concrete according to the formulation (1) was produced. Three slabs were produced by moulding of the concrete according to the formulation (1). After storage for 14 days, a surface treatment of the slabs was carried out. The coating (1) according to the invention was disposed on a face of the first and the second slab. No coating was disposed on the third slab.

Seven days after the surface treatment the first slab was subjected to UV radiation with a wavelength of 254 nm for 1 hour then a wetting test consisting of depositing a drop of water on the surface of the slabs. The measured contact angles are presented in the following Table 8:

TABLE 8

| | | Contact angle measured 5 seconds |
|---|---|---|
| | Contact angle measured 5 seconds | after deposition of the drop |
| Contact angle measured 5 seconds | after deposition of the drop | of water on the first slab |
| after deposition of the drop | of water on the second slab | comprising the coating (1) |
| of water on the third slab | comprising the coating (1) | according to he invention and |
| without coating (°) | according to the invention (°) | subjected to UV radiation (°) |
| 42 | 16 | 0 |

In the absence of UV radiation, the surface of the concrete element covered by the coating (1) has a pronounced hydrophilic character. After exposure to the UV radiation the hydrophilic character of the surface of the concrete element covered by the coating (1) is improved since the surface of the concrete element covered by the coating (1) becomes superhydrophilic.

The hydrophilic or superhydrophilic character facilitates the formation of a film of water on the surface of the concrete element. The fact that the concrete of the concrete element is an ultra-high-performance concrete facilitates the flow of the film of water thus formed in so far as the ultra-high-performance concrete has a lesser roughness than a conventional concrete.

### Example 6

Concrete slabs were prepared using formulations (1), (2) and (3) and their surface roughness was measured using a Mitutoyo SURFTEST SJ-201 apparatus.

The results obtained were:

Rₐ=0.8 μm(±0.4 μm) Formulation (1)

Rₐ=0.8 μm(±0.4 μm) Formulation (2)

Rₐ=5.3 μm(±1.2 μm) Formulation (3)

### Example 7

A concrete according to the formulation (3) was produced. Two slabs were produced by moulding of the concrete according to the formulation (3) in a mould.

After storage for 14 days, a surface treatment of the slabs was carried out. The coating (1) according to the invention was disposed on a face of the first slab. No coating was disposed on the second slab.

The procedure of Example 1 was then followed using coating (1) to obtain the results presented in the following Table 9:

TABLE 9

| | Development of the | Development of the stain after |
|---|---|---|
| | stain after 4 weeks | 4 weeks for the first slab |
| | for the second slab | comprising the coating (1) |
| Product | without coating | according to the invention |
| espresso coffee | slightly reduced | completely disappeared |
| red wine | slightly reduced | completely disappeared |
| lemon juice | completely disappeared | completely disappeared |
| methylene blue | very slightly reduced | completely disappeared |
| sunflower oil | very slightly reduced | completely disappeared |
| permanent | very slightly reduced | slightly reduced |
| marker | | |

The concrete element covered by the coating (3) exhibit surface properties which make it possible to degrade the stains produced during the exposure to sunlight.

### Example 8

A concrete according to the formulation (3) was produced. Two slabs were produced by moulding of the concrete according to the formulation (3).

After storage for 14 days a surface treatment of the slabs was carried out. The coating (1) according to the invention was disposed on a face of the first slab. No coating was disposed on the second slab.

After the surface treatment, the slabs were stored at 35° C. for 7 days in an atmosphere at 100% humidity. A visual inspection of the treated face of the slabs was carried out. The results of the visual inspections are presented in the following Table 10:

TABLE 10

| | Second | First slab |
|---|---|---|
| | slab | comprising the |
| | without | coating (1) according |
| Visual inspection | coating | to the invention |
| Formation of bubbles | — | No formation of |
| | | bubbles in the |
| | | coating |
| Formation of light | Yes | No |
| and dark patches | | |

The concrete element covered by the coating (3) according to the invention does not exhibit patches or bubbles.

### Example 9

A concrete according to the formulation (3) was produced. Three slabs were produced by moulding of the concrete according to the formulation (3).

After storage for 14 days, a surface treatment of the slabs was carried out. The coating (1) according to the invention was disposed on a face of the first and the second slab. No coating was disposed on the third slab.

Seven days after the surface treatment the first slab was subjected to UV radiation with a wavelength of 254 nm for 1 hour then a wetting test consisting of depositing a drop of water on the surface of the slabs. The measured contact angles are presented in the following Table 11:

TABLE 11

| | | Contact angle measured 5 seconds |
|---|---|---|
| | Contact angle measured 5 seconds | after deposition of the drop |
| Contact angle measured 5 seconds | after deposition of the drop | of water on the first slab |
| after deposition of the drop | of water on the second slab | comprising the coating (1) |
| of water on the third slab | comprising the coating (1) | according to he invention and |
| without coating (°) | according to the invention (°) | subjected to UV radiation (°) |
| 69 | 47 | 10 |

In the absence of UV radiation, the surface of the concrete element covered by the coating (1) has a pronounced hydrophilic character. After exposure to the UV radiation the hydrophilic character of the surface of the concrete element covered by the coating (1) is improved since the surface of the concrete element covered by the coating (1) becomes superhydrophilic.

The hydrophilic or superhydrophilic character facilitates the formation of a film of water on the surface of the concrete element. The fact that the concrete of the concrete element is a high-performance concrete facilitates the flow of the film of water thus formed in so far as the high-performance concrete has a lesser roughness than a conventional concrete.

1. A method for the treatment of a concrete surface, which method comprises:
at least partially covering the surface with a first coating which is substantially transparent and substantially impermeable to water; and
at least partially covering said first coating with a second coating which is substantially transparent and photocatalytic;
the concrete surface having an average roughness Rₐ less than about 10 μm.

2. A method according to claim 1, wherein the covering by the first coating comprises depositing a first substantially transparent layer comprising a waterproofing agent on at least a part of said surface.

3. A method according to claim 1, wherein covering said first coating with the second coating comprises:
covering said first coating with a second substantially transparent layer comprising an organic binder; and
covering said second layer with a third substantially transparent layer comprising a photocatalytic agent.

4. A method according to claim 1, wherein the concrete comprises, in parts by weight:
100 parts of Portland cement;
50 to 200 parts of a sand having a single grading with a D10 to a D90 of 0.063 to 5 mm, or a mixture of sands, the finest sand having a D10 to a D90 of 0.063 to 1 mm and the coarsest sand having a D10 to a D90 of 1 to 5 mm;
0 to 70 parts of a pozzolanic or non-pozzolanic material of particles or a mixture thereof having a mean particle size less than 15 μm;
0.1 to 10 parts of a water-reducing superplasticizer; and
10 to 32 parts of water.

5. A method according to claim 1, wherein the first coating comprises an organosilane or an organosilane derivative.

6. A method according to claim 1, wherein the second coating comprises an acrylic polymer or an acrylic polymer derivative.

7. A method according to claim 1, wherein the second coating comprises titanium dioxide particles.

8. A method according to claim 1, wherein the surface treated is substantially free from visible surface defects.

9. A concrete element comprising a surface having an average roughness Rₐ less than about 10 μm treated by the method according to claim 1.

10. A concrete element comprising a concrete surface having an average roughness Rₐ less than about 10 μm, covered at least in part by a first substantially transparent and substantially impermeable coating, the first coating being covered at least in part by a second substantially transparent and photocatalytic coating.
